(19) United States
(12) Patent Application Publication
(10) Pub. No.: US 2009/0117777 A1
(43) Pub. Date: May 7, 2009

(54) KEYBOARD, VIDEO AND MOUSE (KVM) SWITCH

(76) Inventor: Kevin Chen, Taipei Hsien (TW)

Correspondence Address: Patterson & Sheridan, LLP, Suite 100, 595 Shrewsbury Avenue, Shrewsbury, NJ, 07702, US

(21) Appl. No.: 12/352,219

(22) Filed: Jan. 12, 2009

Related U.S. Application Data
(63) Continuation-in-part of application No. 11/317,632, filed on Dec. 22, 2005.
Application No. 11/317,632 is a continuation-in-part of application No. 10/190,015, filed on Jul. 8, 2002, now Pat. No. 7,035,112.

(51) Int. Cl. H01R 11/00

(52) U.S. Cl. 439/502

(57) ABSTRACT

A cable device including a plurality of cables and connecting ports. The cable device may act as a keyboard, video and mouse (KVM) switch system that facilitates controlling different computers with one set of keyboard, video and mouse. In one embodiment, a cable device includes a switching circuit, a plurality of connector ports electrically coupled to the switching circuit, a first cable fixedly connected to the switching circuit, the first cable comprising at least one first connector plug, and a second cable fixedly connected to the switching circuit, the second cable comprising at least one second connector plug, wherein the switching circuit operably selects which of the first and second cables is in communication with the connector ports.

### CROSS-REFERENCE TO RELATED APPLICATIONS

This application is a continuation-in-part of U.S. patent application Ser. No. 11/317,632 filed Dec. 22, 2005 (Attorney Docket No. ATEN/P051-2), which is a continuation-in-part application of U.S. patent application Ser. No. 10/190,015 filed Jul. 8, 2002, now U.S. Pat. No. 7,035,112, (Attorney Docket No. ATEN/P051), all of which are incorporated by reference in their entireties.

### BACKGROUND

1. Field of the Invention

Embodiments of the present invention generally relate to an improved keyboard, video and mouse (KVM) switch for users to automatically switch between two or more computers.

2. Description of the Related Art

Computers are becoming more prevalent in both personal and commercial uses, and are often considered requisite “tools” for work, learning, leisure activities in daily lives. In certain environments, a user needs to be able to access to multiple computers simultaneously. For example, a user may have a computer dedicated to work, such as a computer used for stock trading, as well as a second computer limited to non-work activities, such as a computer used for browsing the World-Wide-Web or playing video games. Currently, for users who need to access two or more computers simultaneously, instead of using multiple sets of keyboard, monitor and mouse for each computer, an automatic switching device commonly referred to as a Keyboard, Video and Mouse (KVM) switch is used. The KVM switch allows the user to use one keyboard, monitor and mouse to control two or more computers.

Typically, the KVM switch contains a circuit that enables switches of a set of keyboard, mouse and monitor among different computers. Thus, a first set of cables are configured to transmit signal from a first keyboard (keyboard signal cable), a first mouse (mouse signal cable) and a first monitor (video signal cable) to the KVM switch. The signal from the KVM switch system is then transmitted to a second set of cables to the computer. Typically, each computer has one set of keyboard (keyboard signal cable), mouse (mouse signal cable) and monitor (video signal cable) to transmit signal for the computer. Accordingly, in the case wherein at least two computers having two separate sets of keyboard, video, and mouse cables are used, these two separate sets of the cables are eliminated and reduced to be controlled by a single set of keyboard, video, and mouse cables connected to the KVM switch system. As the number of computers connected to the KVM switch increases, the number of the cables required to connect each computer to the KVM switch must increase as well. Therefore, cable line management becomes increasingly problematic due to limited space and capacity restrictions. Further, as the number of cables increase, the likelihood that one of cables may become loose and disconnected from the KVM switch also increases, thereby resulting in increased inconvenience and confusion to the users. Additionally, as the types of applications utilized on computers increases, the types of output ports and cables are required to couple output signals to the KVM switch will also increase as wall.

Therefore, there is a need for a KVM switch system with different cable and output configurations.

### SUMMARY OF THE INVENTION

Embodiments of the invention describe a KVM switch system having a plurality of cables. Each cable may have a plurality of connector plugs coupled thereto for different electronic applications, such as USB, PS/2, VGA, DVI, keyboard, audio, monitor, mouse, and the like. The KVM switch system may be in form of a cable device having a switch circuit formed therein.

In one embodiment, a cable device includes a switching circuit, a plurality of connector ports electrically coupled to the switching circuit, a first cable fixedly connected to the switching circuit, the first cable comprising at least one first connector plug, and a second cable fixedly connected to the switching circuit, the second cable comprising at least one second connector plug, wherein the switching circuit operably selects which of the first and second cables is in communication with the connector ports.

In another embodiment, a cable device includes a switching circuit, a plurality of connector ports electrically coupled to the switching circuit, wherein the connector ports connected to a keyboard, mouse and monitor, a first cable fixedly connected to the switching circuit, the first cable comprising at least one first connector plug for connecting to a first computer, and a second cable fixedly connected to the switching circuit, the second cable comprising at least one second connector plug for connecting to a second computer, wherein the switching circuit operably selects which of the first and second cables is in communication with the connector ports.

In yet another embodiment, a cable device includes a switching circuit, a plurality of connector ports electrically coupled to the switching circuit, a first cable fixedly connected to the switching circuit, the first cable comprising a first keyboard connector plug, a first monitor connector plug, and a first mouse connector plug, and a second cable fixedly connected to the switching circuit, the second cable comprising a second keyboard connector plug, a second monitor connector plug, and a second mouse connector plug, wherein the switching circuit operably selects which of the first and the second cables is in communication with the connector ports.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

FIG. 1A depicts a front view of a keyboard, video and mouse (KVM) switch according to one embodiment of the present invention;

FIG. 1B is a cross sectional view of a body of the keyboard, video and mouse (KVM) switch depicted in FIG. 1A;

FIG. 2 is a top plan view of a keyboard, video and mouse (KVM) switch configured in accordance with one embodiment of the present invention;

FIG. 3 is a bottom plan view of the keyboard, video and mouse (KVM) switch of FIG. 2;

FIG. 4 is a right elevation view of the keyboard, video and mouse (KVM) switch of FIG. 2;

FIG. 5 is a rear elevation view of the keyboard, video and mouse (KVM) switch of FIG. 2;

FIG. 6 is a left elevation view of the keyboard, video and mouse (KVM) switch of FIG. 2;

FIG. 7 is a front elevation view of the keyboard, video and mouse (KVM) switch of FIG. 2;

FIG. 8 is a top perspective view of the keyboard, video and mouse (KVM) switch of FIG. 2;

FIG. 9 is a bottom perspective view of the keyboard, video and mouse (KVM) switch of FIG. 2;

FIG. 10 is a block diagram of a system in which the keyboard, video and mouse (KVM) switch may be used, configured in accordance with one embodiment of the present invention;

FIG. 11A-B depicts a front view of a keyboard, video and mouse (KVM) switch according to another embodiments of the present invention; and

FIG. 12 depicts a front view of a keyboard, video and mouse (KVM) switch according to another embodiment of the present invention.

It is to be noted, however, that the appended drawings illustrate only typical embodiments of this invention and are therefore not to be considered limiting of its scope, for the invention may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention include a cable device including a plurality of cables and a plurality of connecting ports. The cable device may act as a keyboard, video and mouse (KVM) switch system that facilitates controlling different computers with one set of keyboard, video and mouse.

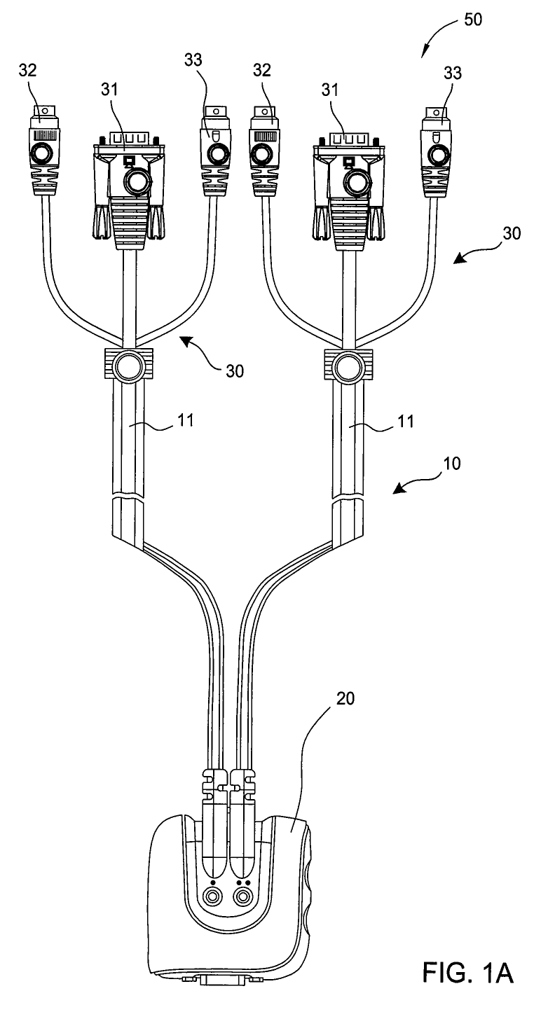

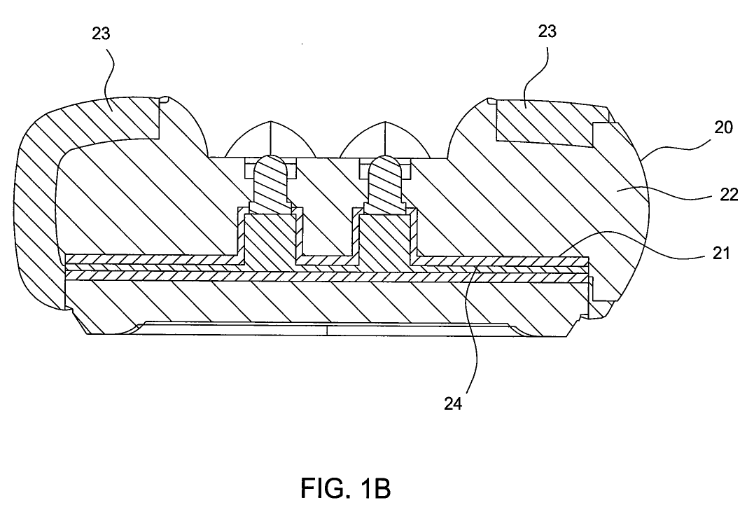

FIG. 1A depicts a front view of a KVM switch system 10 according to one embodiment of the present invention. The KVM switch system 10 includes a main body 20 having connector ports provided on external walls thereof, and more than one or two sets of cable-connected connector plugs 30 directly extended from the main body 20. The main body 20 has an integral enclosure, as shown in FIG. 1B. The integral enclosure includes a circuit-protecting layer 21 that covers enclosing a circuit board 24 within the main body 20. An outer case 22 encloses the circuit-protecting layer 21. An anti-slip layer 23 coats a portion of an outer surface of the outer case 22. It is noted that the circuit-protecting layer 21 of the main body 20 is in close contact with the circuit board 24, so that the circuit board 24 is isolated from and protected against external environment. The circuit-protecting layer 21 prevents electronic elements (not shown) soldered onto the circuit board 24 for becoming loose or damaged even if the main body 20 is vibrated or impacted. Moreover, the circuit-protecting layer 21 also isolates from moisture in the air, thereby enhancing good electric performance. In one embodiment, the circuit protection layer 21, the outer case 22, and the anti-slip layer 23 are injection molded, and in another embodiment, the injected molded over the circuit board 24.

Referring back to FIG. 1A, each set of the cable-connected connector plugs 30 includes a central processing unit (CPU) signal cable connector plug (or a video cable connector plug) 31, a keyboard signal cable connector plug 32, and a mouse signal cable connector plug 33. The cable-connected connector plugs 31, 32 and 33 are adapted to plug in corresponding connector plug (not shown) on computer configuration to which the KVM switch system 10 is to be connected. The circuit board 24 is electrically connected to the sets of cable-connected connector plug 30 via signal cables 11.

In one embodiment, the KVM switch system 10 may be in form of a cable device 50 having the switching circuit (embodied in the circuit board 24) formed within the body of the cable 11 so that each cable 11 is fixedly and electrically connected to the switching circuit formed in the cable device 50. By such design, the body 20 where the circuit board, e.g., the switching circuit, is originally located may be eliminated, thereby reducing size and manufacturing cost of the cable device 50. In this embodiment, the connector ports originally formed in the body 20 may be positioned in any suitable places along the length of the cable 11. In one embodiment, the cable device 50 has first matched pair of video cable connector plugs, a second matched pair of keyboard connector plugs, and a third matched pair of mouse connector plugs 33 from each pair of the cable of in the cable device 50.

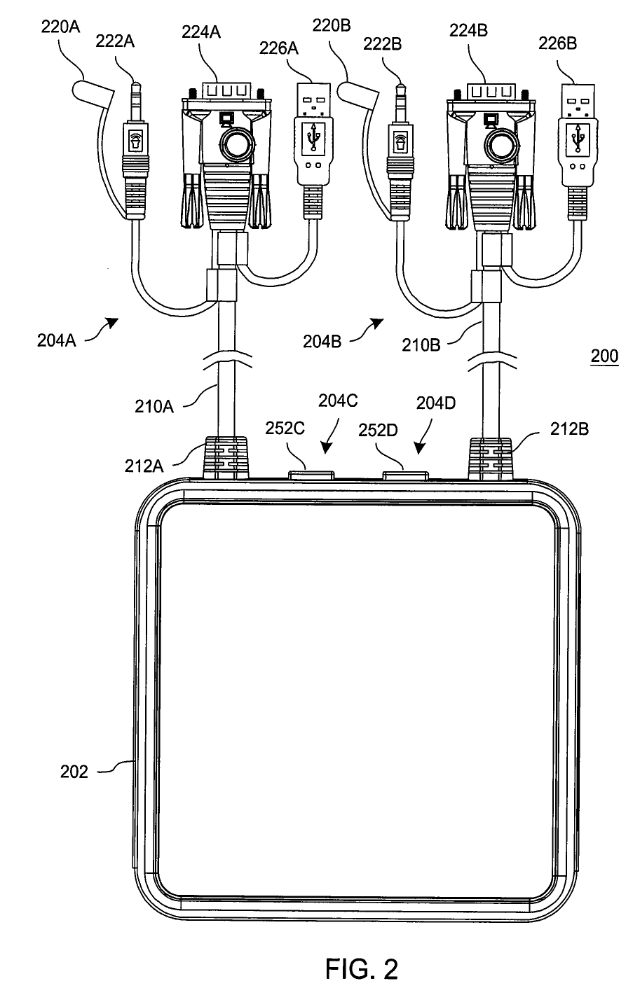

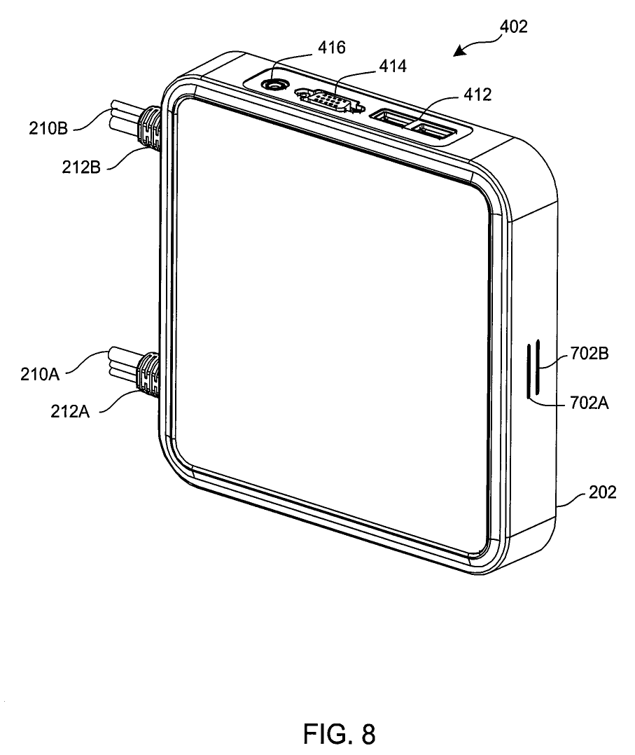

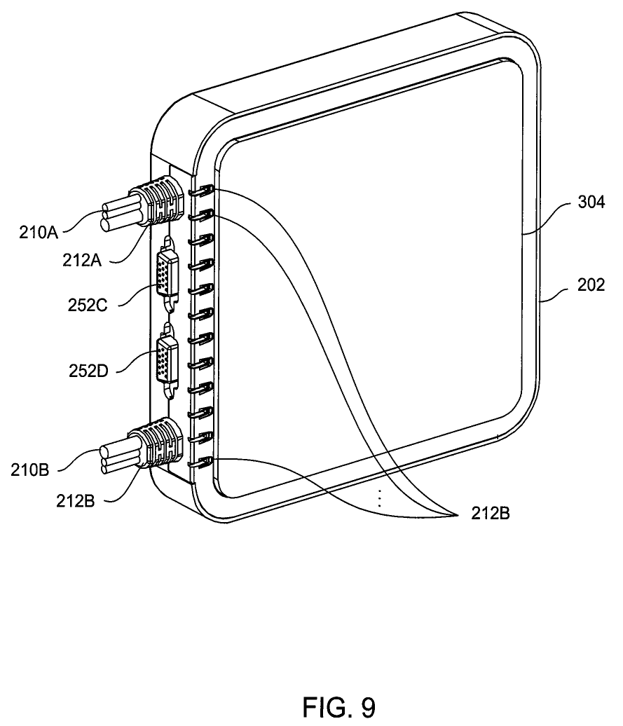

FIG. 2 illustrates a KVM switch device 200 configured in accordance with another embodiment of the present invention. The embodiment of the KVM switch device 200 is also further described with referenced to FIG. 8, which is a perspective view of the top of KVM switch device 200, and FIG. 9, which is a perspective view of the bottom of KVM switch device 200. The KVM switch device 200 includes a body 202, from which a first output 204A and a second output 204B extends. In one embodiment, the first output 204A and the second output 204B includes a first cable 210A and a second cable 210B, respectively, integrated into the body 202. Each cable 210A, 210B is attached to body 202 via a strain relief. Thus, the first cable 210A and the second cable 210B are permanently attached to the body 202 via a first strain relief 212A and a second strain relief 212B, respectively. In one embodiment, the first cable 210A and the second cable 210B are integrally formed (e.g., molded) with the body 202, such that the cables 210A, 210B are sealed to the body 202. Extending from the first cable 210A and the second cable 210B are a first plurality of plugs and a second plurality of plugs, respectively, each having an audio plug (222A, 222B), with a plug cover (220A, 220B); a video plug (224A, 224B); and a peripheral plug (226A, 226B). In one embodiment, each peripheral plug (226A, 226B) is compatible for mating with a Universal Serial Bus (USB) standard device as promulgated by the USB Implementers Forum, Inc. In other embodiments, each peripheral plug (226A, 226B) is compatible for mating with other peripheral standards, such as the PS/2 connector standard as developed by IBM Corporation.

A third output 204C and a fourth output 204D is also located on the body 202. In one embodiment, the third output 204C and the fourth output 204D includes a first cable connector 252C and a second cable connector 252D, respectively, where each cable connector 252C, 252D is configured to be connected to a detachable cable that contains a plurality of plugs such as audio plugs, video plugs, and peripheral plugs similar to the plugs on the first cable 210A and the second cable 210B. In another embodiment, the detachable cable that may be connected to first cable connector 252C and/or second cable connector 252D may contain a different number of plugs as compared to the first cable 210A or the second cable 210B. For example, the detachable cable may only contain a video plug and one peripheral plug.

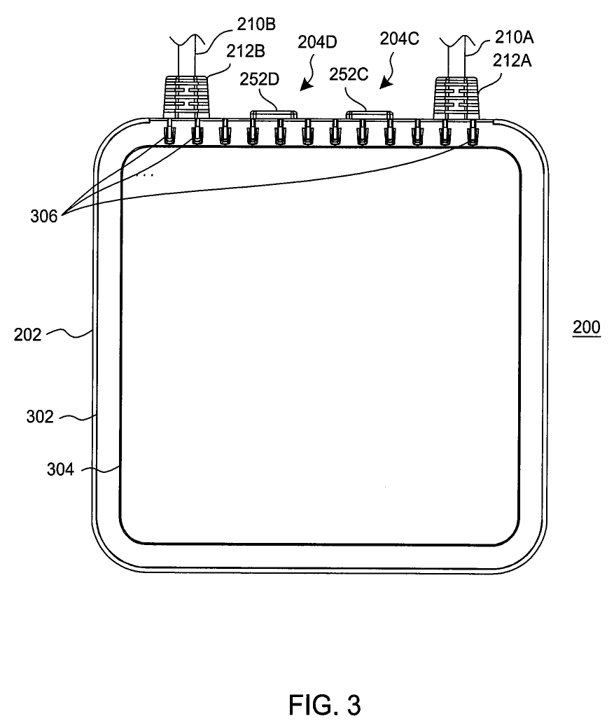

FIG. 3 illustrates a bottom plan view of KVM switch device 200 having a bottom side 302 includes a padding 304 and a plurality of vent slots 306. In one embodiment, the padding 304 is comprised of a material that provides non-slip capabilities. In one embodiment, materials that may be used include rubber-based compounds or polymers. In another embodiment, material such as cloth may be used.

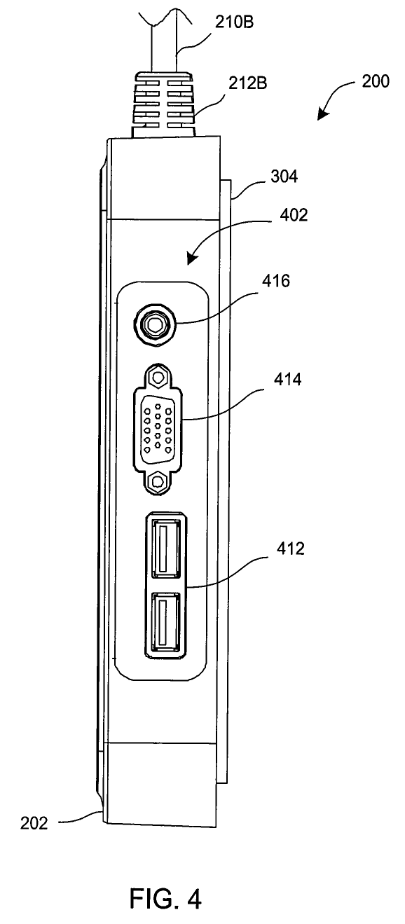

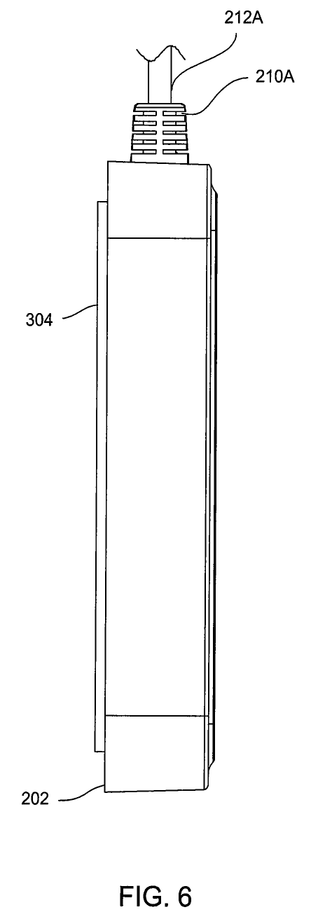

FIG. 4 illustrates a view of the right side of KVM switch device 200 having a plurality of computer peripheral ports 402 including a pair of peripheral ports 412, a video port 414, and an audio port 416. In one embodiment, the pair of peripheral ports 412 is similar to the peripheral plug (226A, 226B), such that the computer peripheral communication standard with which pair of peripheral ports 412 is compatible is the same standard with which peripheral plug (226A, 226B) is compatible. For example, the pair of peripheral ports 412 and the peripheral plug (226A, 226B) are compatible with the USB standard. In another embodiment, the pair of peripheral ports 412 and peripheral plug (226A, 226B) are compatible with different computer peripheral interconnection standards and the KVM switch device 200 needs to perform certain translations of the signals going to and from the computer peripherals coupled to the plug/ports, as further discussed below. In contrast, FIG. 6 is a view of the left side of KVM switch device 200.

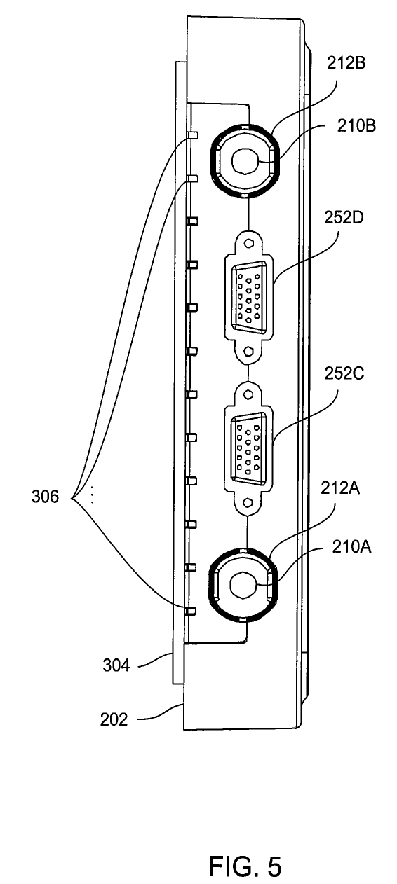

Referring now to FIG. 5, is a rear elevation view of illustrating how the first cable 210A, the second cable 210B, the first cable connector 252C and the second cable connector 252D are integrated into the body 202 and how plurality of vent slots 306 is configured to allow the interior of KVM switch device 200 to ventilate with the surrounding environment. In one embodiment, the electronics internal KVM switch device 200 are sealed from moisture, and any liquid that may accidentally reach the interior will not affect the electronics because they are so sealed.

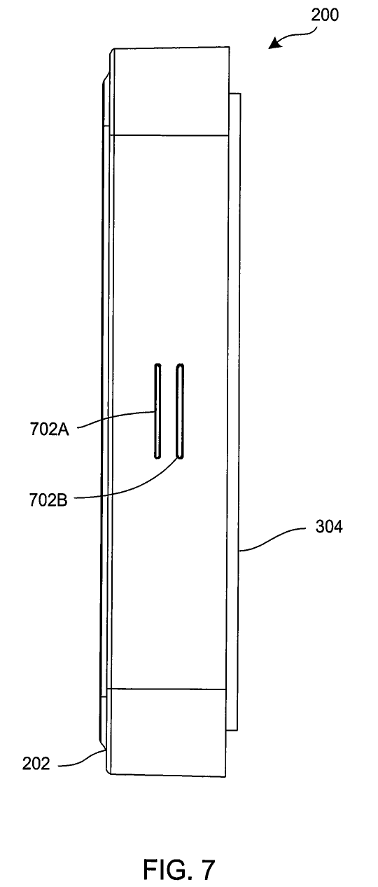

FIG. 7 is a view of the front of KVM switch device 200, where a pair of indicator lights 702A and 702B indicate the status of KVM switch device 200. The body 202 contains a switching circuit, similar to the circuit board 24 within the main body 20 depicted in FIG. 1B, that switches the signals received from plurality of computer peripheral ports 402 to one or more sets of outputs 204A-204D. In one embodiment, each of the indicator lights indicates the operational status of one of the computers that is connected to KVM switch device 200. For example, indicator light 702A may be lit to indicate that KVM switch device 200 is operating to electrically couple the signals received from plurality of computer peripheral ports 402 to first output 204A. The indicator light 702B can be lit to indicate if KVM switch device 200 is operating to electrically couple the signals received from the plurality of computer peripheral ports 402 to the second output 204B. In another embodiment, the indicator lights 702A, 702B may signal that the KVM switch device 200 is operating to electrically couple the signals received from plurality of computer peripheral ports 402 to third output 204C or fourth output 204D. In yet another embodiment, the indicator lights 702A, 702B may indicate the coupling of the signals from plurality of computer peripheral ports 402 to any of the outputs through a series or sequence of light flashes.

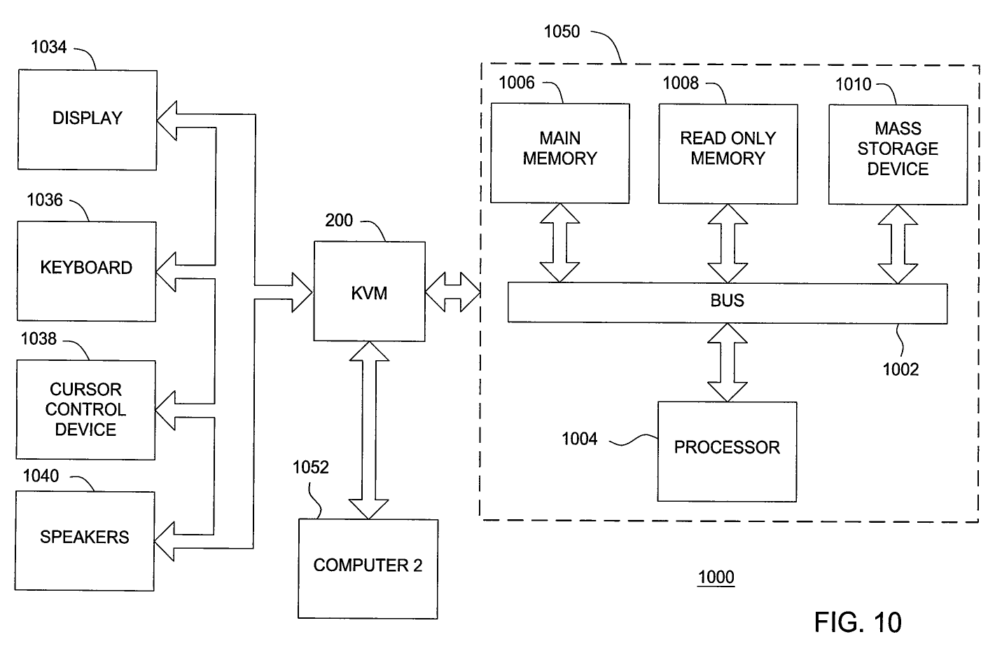

FIG. 8 depicts a top perspective view of the keyboard, video and mouse (KVM) switch 200 and FIG. 9 is a bottom perspective view of the keyboard, video and mouse (KVM) switch 200. FIG. 10 illustrates an example of a system 1000 in which the features of the present invention may be implemented. The system 1000 includes a first computer system 1050 and a second computer system 1052 that are selectively and switchedly connected to the computer peripherals that are coupled to KVM switch device 200. The first computer system 1050 and the second computer system 1052 are general purpose computer systems, as further described below. The following description, although specifically referring to the first computer system 1050, is applicable to the second computer system 1052.

The first computer system 1050 includes a bus 1002 for communicating information between the components in the first computer system 1050, and a processor 1004 coupled with the bus 1002 for executing software code, or instructions, and processing information. The first computer system 1050 further comprises a main memory 1006, which may be implemented using random access memory (RAM) and/or other random memory storage device, coupled to the bus 1002 for storing information and instructions to be executed by the processor 1004. The main memory 1006 also may be used for storing temporary variables or other intermediate information during execution of instructions by the processor 1004. The first computer system 1050 also includes a read only memory (ROM) 1008 and/or other static storage device coupled to the bus 1002 for storing static information and instructions for the processor 1004. Further, a mass storage device 1010, such as a magnetic disk drive and/or or an optical disk drive, may be coupled to the first computer system 1050 for storing information and instructions. Although not illustrated, the first computer system 1050 may optionally include video capture/output cards, camera devices, and many other conventional options.

In the configuration shown in FIG. 10, the KVM switch device 200 is used to allow a single set of peripherals, e.g., a display device 1034, an alphanumeric input device 1036, a cursor control device 1038 and speakers 1040 to be selectively coupled to the first computer system 1050 or the second computer system 1052. The computer systems 1050, 1052 may be connected to any of the outputs 204A to 204D of the KVM switch device 200 using the first cable 210A, the second cable 210B or, as noted above, additional cables connected to the first cable connector 252C and the second cable connector 252D. Up to four computer systems may be connected to KVM switch device 200 if all four outputs 204A to 204D are used, with one computer system attached to each output.

In one exemplary configuration, the first computer system 1050 is coupled to the display device 1034 using the video plug 224A on the first cable 210A of the KVM switch device 200. The display device 1034 is a device, such as a cathode ray tube (CRT) or a liquid crystal display (LCD), used for displaying information to a user so that, for example, graphical or textual information may be presented to the user. The alphanumeric input device 1036, including alphanumeric and other keys, is coupled to one of the ports of pair of peripheral ports 412 on KVM switch device 200 for communicating information and/or user selection commands to processor 1004 of first computer system 1050. In one embodiment, the peripheral standard that is being used is based on the USB standard, as discussed above, then either one of the ports of pair of the peripheral ports 412 may be used. The first computer 1050 is then coupled to the KVM switch device 200 using the peripheral plug 226A on the first cable 210A.

Another type of a user input device shown in the figure is the cursor control device 1038, such as a conventional mouse, touch mouse, trackball, touchpad or other type of cursor direction keys for communicating direction information and command selection to first computer system 1050 and for controlling movement of a cursor on the display 1034. Similar to the alphanumeric input device 1036, the cursor control device 1038 may be plugged into one of the ports of the pair of peripheral ports 412 on the KVM switch device 200. The first computer system 1050, which is already coupled to KVM switch device 200 using peripheral plug 226A on first cable 210A, will receive the direction information and command selection generated by the cursor control device 1038. Various other types of input devices, including, but not limited to the input devices described herein, unless otherwise noted, may be coupled to the KVM switch device 200 using the pair of peripheral ports to allow the user to provide command or input to the first computer system 1050.

In one embodiment, if more than two devices are to be coupled to the KVM switch device 200, one or more hubs (e.g., one or more USB hubs) may be connected to the pair of peripheral ports 412. Thus, more than two computer peripheral devices may be coupled to KVM switch device 200. Specifically, in addition to the alphanumeric input device 1036 and the cursor control device 1038, other devices such as printers, image scanners, cameras and microphones may be coupled to KVM switch device 200 through the use of devices such as hubs.

Also as illustrated, the speakers 1040 are coupled to the first computer system 1050 via KVM switch device 200. In one embodiment, speakers 1040 are first coupled to audio port 416 of the KVM switch device 200. The audio plug 222A of first cable 210A is then plugged into first computer system 1050.

The first computer system 1050 may also include a communication device (not shown) that is coupled to the bus 1002 for accessing other computer systems, as described below. The communication device may include a modem, a network interface card, or other well-known interface devices, such as those used for interfacing with Ethernet, Token-ring, or other types of networks. In any event, in this manner, the first computer system 1050 may be coupled to a number of other computer systems via a network infrastructure, such as second computer system 1052.

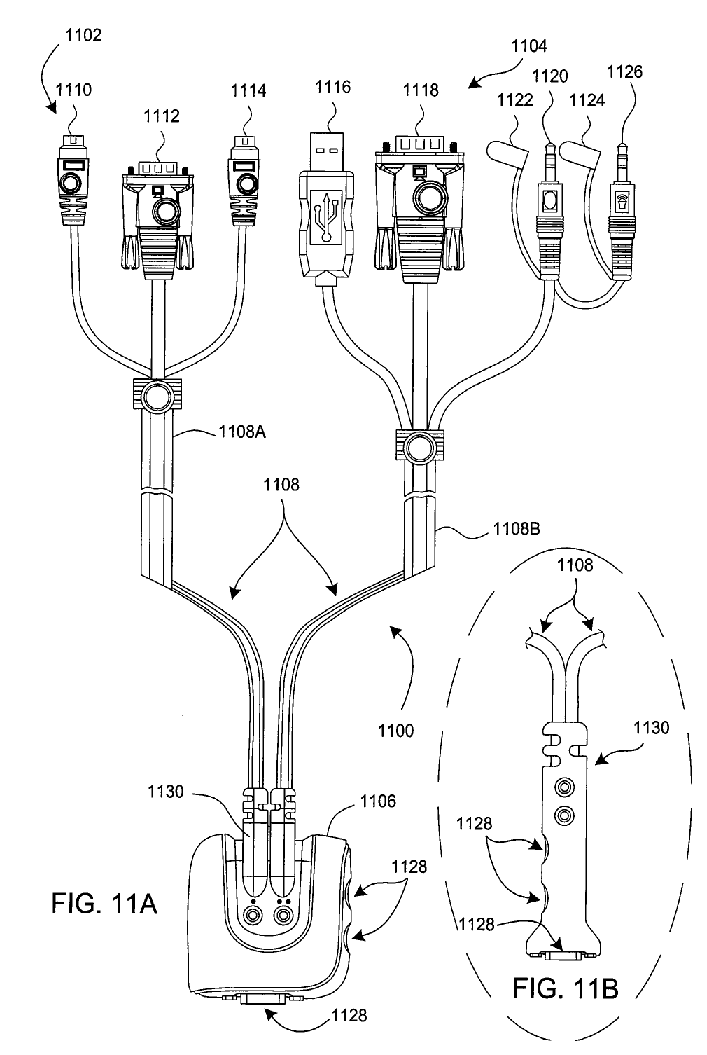

FIG. 11 depicts a cable device 1100 that performs as a KVM switch system, such as the KVM system 10 depicted in FIG. 1 and the KVM system 200 depicted in FIG. 2. The cable device 1100 has at least a first output 1102 and at least a second output 1104 connected to an enclosure 1106 through a plurality of cables 1108 (shown as 1108A and 1108B). Each output 1102, 1104 may be configured to connect to an individual computer system or other suitable computer devices. In one embodiment, the first output 1102 is coupled to the enclosure 1106 through a first cable 1108A and the second output 1104 is coupled to the enclosure 1106 through a second cable 1108B. Each cable 1108A, 1108B is coupled to the enclosure 1106 through a strain relief. In one embodiment, the cable 1108A, 1108B is permanently and fixedly coupled to the enclosure 1106. In the embodiment wherein the enclosure 1106 is not present, the plurality of cables 1108 may be joined opposite the outputs 1102, 1104 as a single cable body line, having a common termination 1130, as shown in FIG. 11B, at the end of the cables 1108.

Referring back to FIG. 11A, in one embodiment, the first output 1102 has a first plurality of connector signal plugs, including a first connector plug 1110, a second connector plug 1112, and a third connector plug 1114 coupled to the first cable 1108A. In one embodiment, the first connector plug 1110 in the first output 1102 is a keyboard signal plug 1110, and the second connector plug 1112 is a central processing unit (CPU) signal cable plug (or a video signal plug) and the third connector plug 1114 is a mouse signal plug 1114. The types and configuration of the each connector plugs 1110, 1112, 1114 comprising the first output 1102 may be matched or different than one or more of the connector plug of the first output 1102. In the exemplary embodiment depicted in FIG. 11, the first connector plug 1110 and the third connector plug 1114 comprising in the first output 1102 are matched, while the first connector plug 1110 (or the third connector plug 1114) and the second connector plug 1112 are different.

The second output 1104 has a second plurality of connector plugs, including a first 1116, a second 1118, a third 1120, and a fourth connector plug 1126 coupled to the second cable 1108B. The first connector plug 1116 is configured to be a peripheral plug 1116. The second connector plug 1118 is configured to be a central processing unit (CPU) signal cable plug (or a video signal plug). The third connector plug 1120 is configured to be an audio signal plugs, such as a speaker plug with a first plug cover 1122. The fourth connector plug 1126 is configured to be another audio signal plug, such as a headphone or microphone plug, with a second plug cover 1124. The number of each plug comprising the first and the second outputs 1102, 1104 may be selected to accommodate different hardware configurations and requirements. Optionally, each connector plugs 1116, 1118, 1120, 1126 may be configured to have different types of connector plugs. In some embodiment, one or more of the outputs 1102, 1104 may have one or more matched connectors. In some embodiments, two or more of the outputs may have one or more of the same type of connector plugs. In one embodiment, the second peripheral plug 1116 is compatible for mating with a Universal Serial Bus (USB) standard device as promulgated by the USB Implementers Forum, Inc. It is noted that each peripheral plug may be selected to match with other peripheral standards, such as the PS/2 connector standard as developed by IBM Corporation.

In one embodiment, the first plurality of connector plugs 1110, 1112, 1114 comprising the first output 1102 and the second plurality of connector signal plugs 1116, 1118, 1120, 1126 comprising the second output 1104 may have one or more match connector plugs. For example, a first connector plug of the first output 1102 may be matched with a first connector plug of the second output 1104. Alternatively, the types of the connector plugs respectively comprising the first 1102 and the second output 1104 may be different or varied based on the requirements and configurations of the computer system to which the connector plugs are to be coupled to. In one embodiment, respective connector signal plugs may be configured as a keyboard connector plug, an audio connector plug, a monitor connector plug, a periphery connector plug, a USB connector plug, a VGA connector plug, a PS/2 connector plug, a DVI connector plug and the like.

In one embodiment, the cable device 1100 has a switching circuit, such as the circuit board 24 of FIG. 1B, embedded and formed in the enclosure 1106. In the embodiment wherein the enclosure 1106 is not present, the switching circuit may be formed in the body of the termination 1130 of the cables 1108, as depicted in FIG. 11B, or any suitable location where the switching circuit may be embedded, formed or molded therein. The cables 1108A, 1108B are electrically connected to the switching circuit configured to bi-directionally transmit signals from a selected port 1130 through the switching circuit to a selected one of the first output 1102 and the second output 1104 of the cable device 1100.

In one embodiment, a plurality of connecting ports 1128 are formed in the enclosure 1106, or the termination 1130 of the cable device 1100. The connecting ports 1128 are electrically coupled to the switching circuit. The switching circuit switches the connection of the connector ports 1128 and a selected one of the first output 1102 or the second output 1104 of the cable device 1100. The connecting ports 1128 are configured to receive detachable cables that terminate in connector plugs, such as an audio plug, a video plug, a peripheral plug or a keyboard plug or other suitable connector plugs, similar to the connector plugs 1110, 1112, 1114, 1116, 1118, 1120, 1126, as described above.

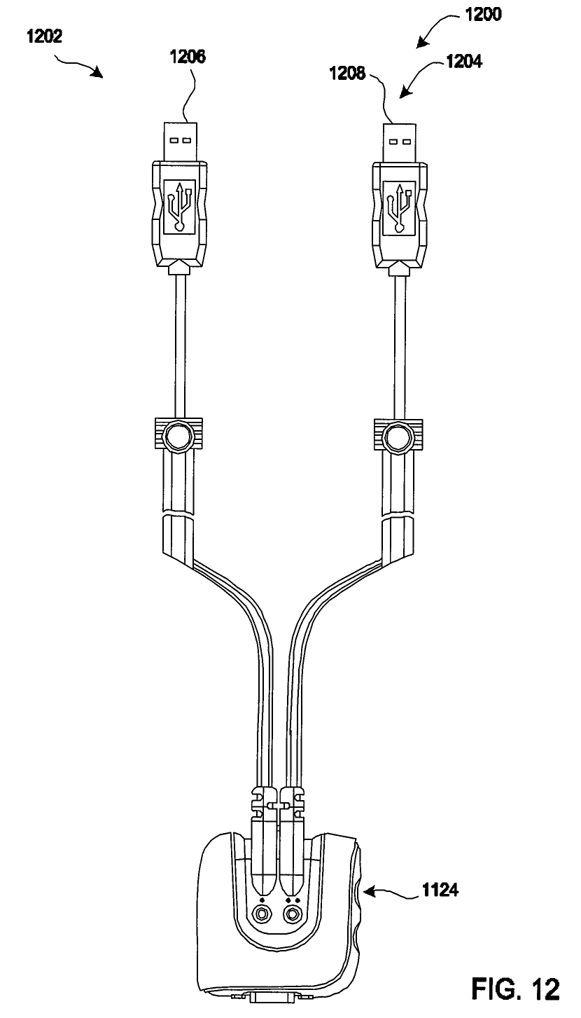

FIG. 12 depicts another embodiment of a cable device 1200, similar to the cable device 1100 depicted in FIG. 11. The cable device 1200 also includes a first output 1202 and a second output 1204. Different from the numbers and types of the connecting plugs formed in FIG. 11, the first output 1202 of the cable device 1200 only contains a first connector plug 1206 and the second output 1204 only contains a second connector plug 1208. In one embodiment, the first connector plug 1206 of the first output 1202 and the second connector plug 1208 of the second output 1204 are matched and both are configured as a periphery plug compatible for mating with a Universal Serial Bus (USB) standard device. It is noted that each peripheral plug may be selected so that it is compatible for mating with other peripheral standards, such as the PS/2 connector standard as developed by IBM Corporation.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, e.g., in an instant messaging service or any general wireless data communication applications, without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments. Accordingly, the present invention is to be defined solely by the scope of the following claims.

While the foregoing is directed to embodiments of the present invention, other and further embodiments of the invention may be devised without departing from the basic scope thereof, and the scope thereof is determined by the claims that follow.

What is claimed is:

1. A cable device comprising:
a switching circuit;
a plurality of connector ports electrically coupled to the switching circuit;
a first cable fixedly connected to the switching circuit, the first cable comprising at least one first connector plug; and
a second cable fixedly connected to the switching circuit, the second cable comprising at least one second connector plug, wherein the switching circuit operably selects which of the first and second cables is in communication with the connector ports.

2. The cable device of claim 1, wherein the first connector plug is selected from the group consisting of a keyboard connector plug, an audio connector plug, a monitor connector plug, a periphery connector plug, a USB connector plug, a VGA connector plug, a PS/2 connector plug and a DVI connector plug.

3. The cable device of claim 1, wherein the second connector plug is selected from the group consisting of a keyboard connector plug, an audio connector plug, a monitor connector plug, a periphery connector plug, a USB connector plug, a VGA connector plug, a PS/2 connector plug and a DVI connector plug.

4. The cable device of claim 1, wherein the first connector plug is different than the second connector plug.

5. The cable device of claim 1, wherein the first connector plug and the second connector plug are matched.

6. The cable device of claim 1, wherein the first cable includes the plurality of first connector plugs.

7. The cable device of claim 1, wherein the second cable includes the plurality of second connector plugs.

8. The cable device of claim 1, further comprising:
an enclosure, wherein the switching circuit is embedded within the enclosure.

9. A cable device comprising:
a switching circuit;
a plurality of connector ports electrically coupled to the switching circuit, wherein the connector ports connected to a keyboard, mouse and monitor;
a first cable fixedly connected to the switching circuit, the first cable comprising at least one first connector plug for connecting to a first computer; and
a second cable fixedly connected to the switching circuit, the second cable comprising at least one second connector plug for connecting to a second computer, wherein the switching circuit operably selects which of the first and second cables is in communication with the connector ports.

10. The cable device of claim 9, wherein the first connector plug is selected from the group consisting of a keyboard connector plug, an audio connector plug, a monitor connector plug, a periphery connector plug, a USB connector plug, a VGA connector plug, a PS/2 connector plug and a DVI connector plug.

11. The cable device of claim 9, wherein the second connector plug is selected from the group consisting of a keyboard connector plug, an audio connector plug, a monitor connector plug, a periphery connector plug, a USB connector plug, a VGA connector plug, a PS/2 connector plug and a DVI connector plug.

12. The cable device of claim 9, wherein the first connector plug is different than the second connector plug.

13. The cable device of claim 9, wherein the first connector plug and the second connector plug are matched.

14. The cable device of claim 9, wherein the first cable includes the plurality of first connector plugs.

15. The cable device of claim 9, wherein the second cable includes the plurality of second connector plugs.

16. The cable device of claim 9, further comprising:
an enclosure, wherein the switching circuit is embedded within the enclosure.

17. A cable device comprising:
a switching circuit;
a plurality of connector ports electrically coupled to the switching circuit;
a first cable fixedly connected to the switching circuit, the first cable comprising a first keyboard connector plug, a first monitor connector plug, and a first mouse connector plug; and
a second cable fixedly connected to the switching circuit, the second cable comprising a second keyboard connector plug, a second monitor connector plug, and a second mouse connector plug, wherein the switching circuit operably selects which of the first and the second cables is in communication with the connector ports.

18. The cable device of claim 17, wherein the first keyboard connector plug, the first monitor connector plug, and the first mouse connector plug are different than the second keyboard connector plug, the second monitor connector plug, and the second mouse connector plug.

19. The cable device of claim 17, wherein the first keyboard connector plug, the first monitor connector plug, the first mouse connector plug and the second keyboard connector plug, the second monitor connector plug, the second mouse connector plug are matched.

20. The cable device of claim 17, further comprising:
an enclosure, wherein the switching circuit is contained within the enclosure.
